(19) United States
(12) Patent Application Publication
(10) Pub. No.: US 2022/0099165 A1
(43) Pub. Date: Mar. 31, 2022

(54) ENGINE ACCESSORY DRIVE SYSTEM AND ONE-PIECE BRACKET FOR SAME

(71) Applicant: Caterpillar Inc., Peoria, IL (US)

(72) Inventors: Quinton Marcus Burcar, Peoria, IL (US); Allen Yao Chen, Dunlap, IL (US)

(73) Assignee: Caterpillar Inc., Peoria, IL (US)

(21) Appl. No.: 17/034,676

(22) Filed: Sep. 28, 2020

(51) Int. Cl. F16H 7/12; F02B 67/06

(52) U.S. Cl. CPC F16H 7/1281; F16H 2007/0893; F02B 67/06

(57) ABSTRACT

An accessory drive system for an engine includes a one-piece bracket supporting a first pulley, and an auto-tensioner including a first arm end coupled to the one-piece bracket, a second arm end, and a tensioner pulley supported for rotation upon the second arm end. The first arm end rotates relative to the one-piece bracket to pivot the auto-tensioner between a first stop position and a second stop position in contact, respectively, with a first tensioner stop and a second tensioner stop formed integrally in the one-piece bracket.

### TECHNICAL FIELD

The present disclosure relates generally to an accessory drive system for an engine, and more particularly to a belt guide and tensioning module in an accessory drive system.

### BACKGROUND

Modern internal combustion engines typically include numerous different components that support the basic operation of the engine by providing for the circulation of fluids, blowing of air, compression of refrigerant for air conditioning, production of electrical power, and for various other purposes. It is common for certain of such accessories, including alternators, water pumps, air conditioner compressors, and others, to be mounted in a front-end accessory drive system. In one common implementation rotation of an engine flywheel drives a belt that extends in a serpentine path about various drive pulleys and idler pulleys to provide rotational power to the various accessories and suitably route the belt. Some engines also rely on such belt drives to power an engine fan.

Due to the numerous different accessory components to be driven, variations in the size, type, and design of engines and the accessories themselves, engineers are often challenged to provide a front end accessory drive system that is robust while also accounting for as many different variations in component selection and configuration as possible. Some of the components and accessory drive systems, including idler pulleys, may be required simply to allow for physical belt routing without interfering with all of the surrounding components. One known pulley system for use in operating engine and vehicular equipment accessories is set forth in U.S. Pat. No. 6,022,286.

### SUMMARY OF THE INVENTION

In one aspect, an accessory drive system for an engine includes a one-piece bracket having an engine-facing side, an outer bracket side, and a plurality of bolting holes extending between the engine-facing side and the outer bracket side. The accessory drive system further includes a first pulley coupled to the one-piece bracket and supported for rotation upon the outer bracket side. The accessory drive system further includes an auto-tensioner having a tensioner arm with a first arm end coupled to the one-piece bracket, a second arm end, and a tensioner pulley supported for rotation upon the second arm end. The first arm end is supported for rotation upon the one-piece bracket to pivot the auto-tensioner about a pivot axis between a first stop position and a second stop position, relative to the one-piece bracket. The accessory drive system further includes a tensioner biaser biasing the auto-tensioner toward the first stop position.

In another aspect, a belt guide and tensioning module for an accessory drive system in an engine includes a one-piece bracket having an engine-facing side, an outer bracket side, and a plurality of bolting holes extending between the engine-facing side and the outer bracket side. The one-piece bracket further includes a first bracket end having a first pulley mounting hole formed therein, a second bracket end having a pivot pin hole formed therein, and a plurality of bolting holes arranged between the first bracket end and the second bracket end and each extending through the one-piece bracket between the engine-facing side and the outer bracket side. The belt guide and tensioning module further includes a first tensioner stop, a second tensioner stop, and an auto-tensioner including a pivot pin received in the pivot pin hole, a tensioner arm having a first arm end coupled to the pivot pin and a second arm end having a second pulley mounting hole formed therein, and a tensioner biaser. The auto-tensioner is supported for rotation about the pivot axis relative to the one-piece bracket, in opposition to a biasing force of the tensioner biaser, from a first stop position in contact with the first tensioner stop to a second stop position in contact with the second tensioner stop.

In still another aspect, a bracket for mounting an idler pulley and an auto-tensioner in an accessory drive system for an engine includes a one-piece bracket body having an engine-facing side and an outer bracket side, a first bracket end, and a second bracket end. The first bracket end includes a pulley mount having a pulley mounting hole, and the second bracket end includes a tensioner mount having a pivot pin hole. The one-piece molded body further includes a plurality of bolt bosses arranged longitudinally between the pulley mount and the tensioner mount and each having formed therein a bolting hole extending between the engine-facing side and the outer bracket side, and the bolting holes being arranged in a triangular pattern. The one-piece bracket body further includes a plurality of outside ribs including a first outside rib and a second outside rib extending between the pulley mount and a first one and a second one, respectively, of the plurality of bolt bosses, and a third outside rib extending between the second one of the plurality of bolt bosses and a third one of the plurality of bolt bosses. The one-piece bracket body further includes a plurality of inside ribs together forming a stiffener connecting between each of the plurality of bolt bosses upon the outer bracket side.

### BRIEF DESCRIPTION OF THE DRAWINGS

FIG. 1 is diagrammatic end view of an internal combustion engine system, according to one embodiment;

FIG. 2 is a diagrammatic view, in perspective, of a belt guide and tensioning module for an accessory drive system in an engine, according to one embodiment;

FIG. 3 is a back view of the belt guide and tensioning module of FIG. 2;

FIG. 4 is a diagrammatic view of a portion of the module of FIGS. 2 and 3;

FIG. 5 is a sectioned view through the module of FIGS. 2-4; and

FIG. 6 is an elevational view of a mounting bracket for a belt guide and tensioning module, according to one embodiment.

### DETAILED DESCRIPTION

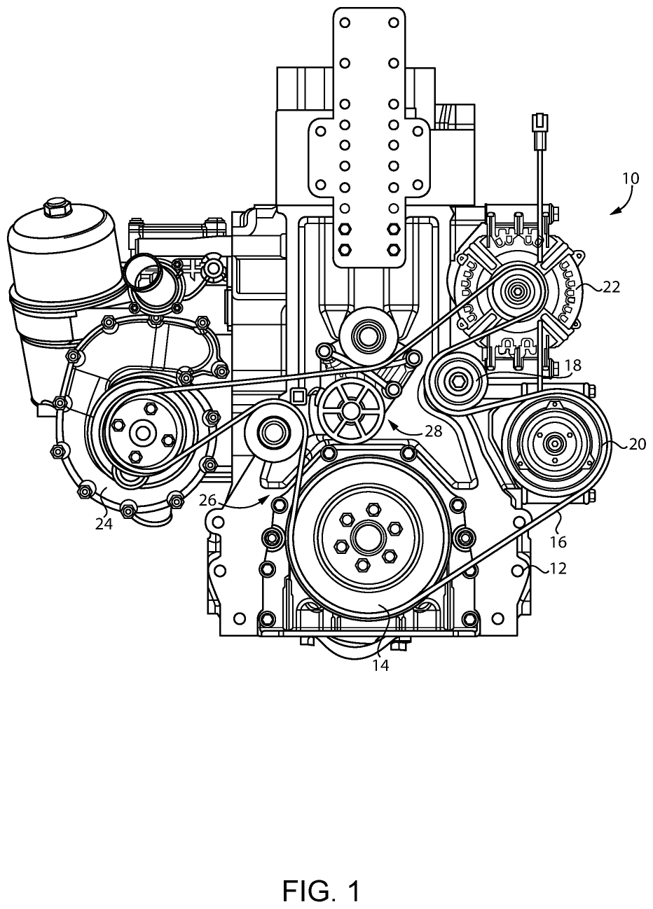

Referring to FIG. 1, there is shown an internal combustion engine system 10, according to one embodiment. Internal combustion engine system 10 includes an engine 12, which may be a compression-ignition engine structured to operate on a liquid fuel such as a diesel distillate fuel. The present disclosure is not thereby limited, however, and engine 12 could be a spark-ignited gasoline engine, a gaseous fuel engine, or a dual fuel engine operating on a mixture of a gaseous fuel and a liquid fuel. Engine 12 may include any number of combustion cylinders in any suitable arrangement, associated with pistons that operate in a conventional manner to rotate a crankshaft. Crankshaft rotation will cause rotation of a flywheel 14 mounted at a front end of engine 12 as shown. Coupled with flywheel 14 is an accessory drive system 26 including a belt 16 extending around pulleys associated with a plurality of accessories 20, 22, and 24. It should be appreciated that while front end mounting of accessory drive system 26 is one practical implementation strategy, in other embodiments an accessory drive system according to the present disclosure could be mounted at a back end of an engine. Accessories 20, 22, 24, may include a water pump, an alternator, and an air conditioner compressor, respectively, however, it should be appreciated that no limitation is intended as to the type or construction of accessories in accessory drive system 26. Accessory drive system 26 may include one or more idler pulleys 18 mounted independently to engine 12, as well as a belt guide and tensioning module 28 (hereinafter “module 28”) that is mounted to engine 12. In a practical implementation strategy module 28 can be bolted to a cylinder block of engine 12 or a housing or other structured supported upon a cylinder block.

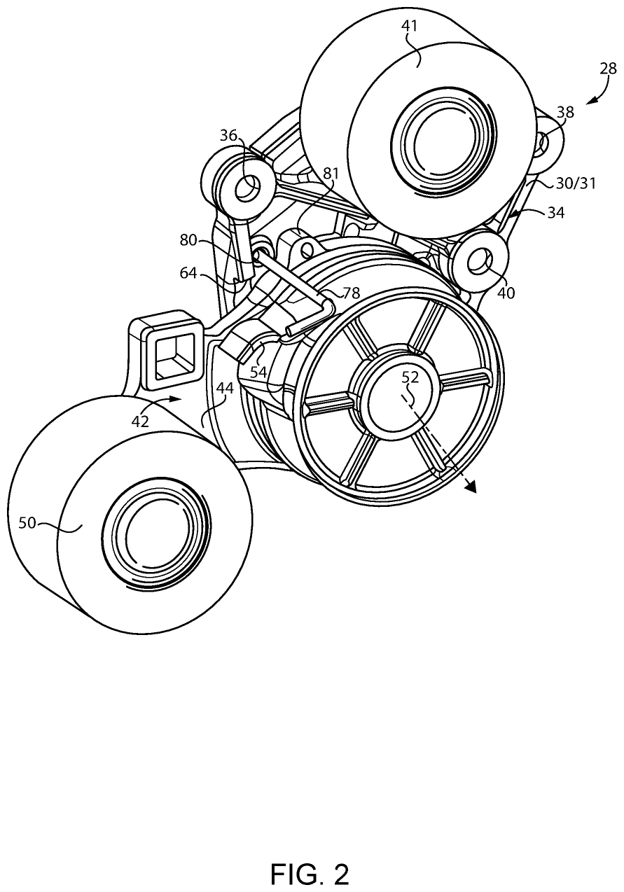

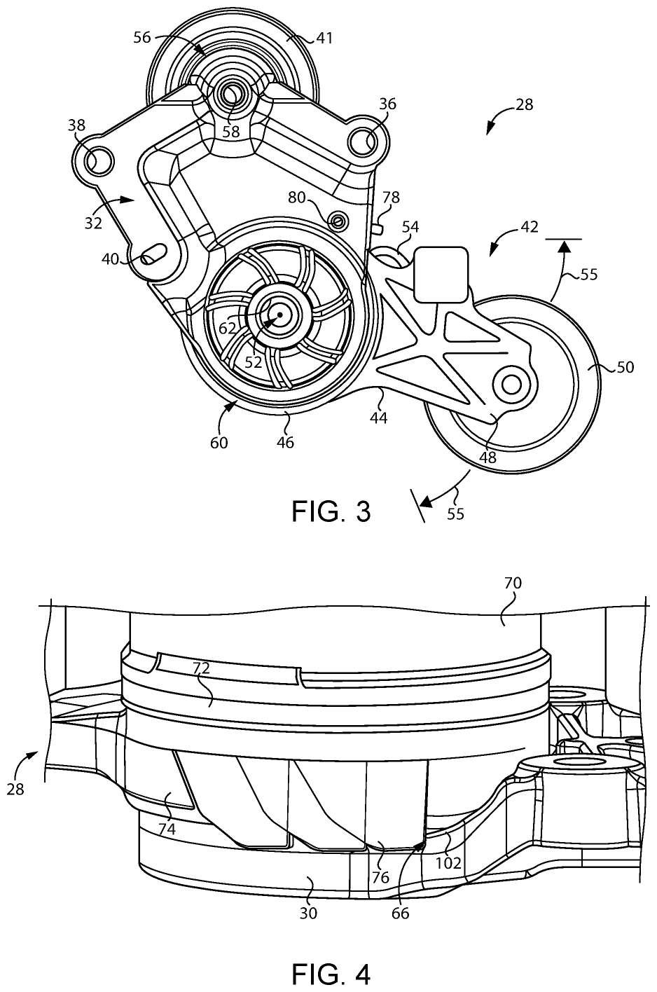

Referring also now to FIGS. 2 and 3, there are shown features of module 28 in greater detail. Module 28 includes a one-piece bracket 30 including a one-piece bracket body 31. Bracket body 31 may include a molded non-metallic body formed, for example, by injection molding or compression molding, but may also be forged, cast, machined or otherwise formed by any suitable technique from any suitable materials, including various metallic materials. Description and discussion herein of one-piece bracket 30 or one-piece bracket body 31 should be understood to refer to either, as the terms are used generally interchangeably. One-piece bracket 30 (hereinafter “bracket 30”) has an engine facing side 32, an outer bracket side 34, and a plurality of bolting holes 36, 38, 40 extending between engine facing side 32 and outer bracket side 34. Module 28 also includes a first pulley 41 coupled to bracket 30 and supported for rotation upon outer bracket side 34. First pulley 41 can be an idler pulley, passively rotating in contact with belt 16 when module 28 is installed for service on engine 12.

Module 28 also includes an auto-tensioner 42 having a tensioner arm 44. Tensioner arm 44 includes a first arm end 46 coupled to bracket 30, a second arm end 48, and a tensioner pulley 50 supported for rotation upon second arm end 48. First arm end 46 is supported for rotation upon bracket 30 to pivot auto-tensioner 42 about a pivot axis 52 between a first stop position and a second stop position, relative to bracket 30. Module 28 further includes a tensioner biaser 54 biasing auto-tensioner 42 toward the first stop position. Those skilled in the art will thus appreciate that module 28 can be installed for service on engine 12, with tensioner pulley 50 rotating in contact with belt 16, and tensioner biaser 54 biasing auto-tensioner 42 and tensioner pulley 50 to tighten belt 16 and to maintain a desired tension of belt 16 in accessory drive system 26.

In FIG. 3, auto-tensioner 42 is shown as it might appear at a third position angularly between the first stop position and the second stop position. Module 28 may include a removable fastener 78 trapped between auto-tensioner 42 and bracket 30. Fastener 78 can include a pin received in a hole 80 formed in bracket 30 and positioned such that a biasing force of tensioner biaser 54 urges auto-tensioner 42 into contact with fastener 78 to fix auto-tensioner 42 at the third position. An installation technician can install module 28 on engine 12, position belt 16 as desired, and then remove fastener 78 to allow biasing force of tensioner biaser 54 to be exerted on belt 16 and tighten the same in preparation for operation of internal combustion engine system 10. Auto-tensioner 42 can include a protrusion 81 that contacts fastener 78. Any other suitable mechanism or strategy for fixing auto-tensioner 42 at a desired position relative to bracket 30 could be used. Tensioner biaser 54 may include a known spiral recoil spring extending circumferentially around pivot axis 52, however, the present disclosure is not thereby limited, and any suitable tensioner biaser including one or more helical coil springs in various orientations might be used in other embodiments.

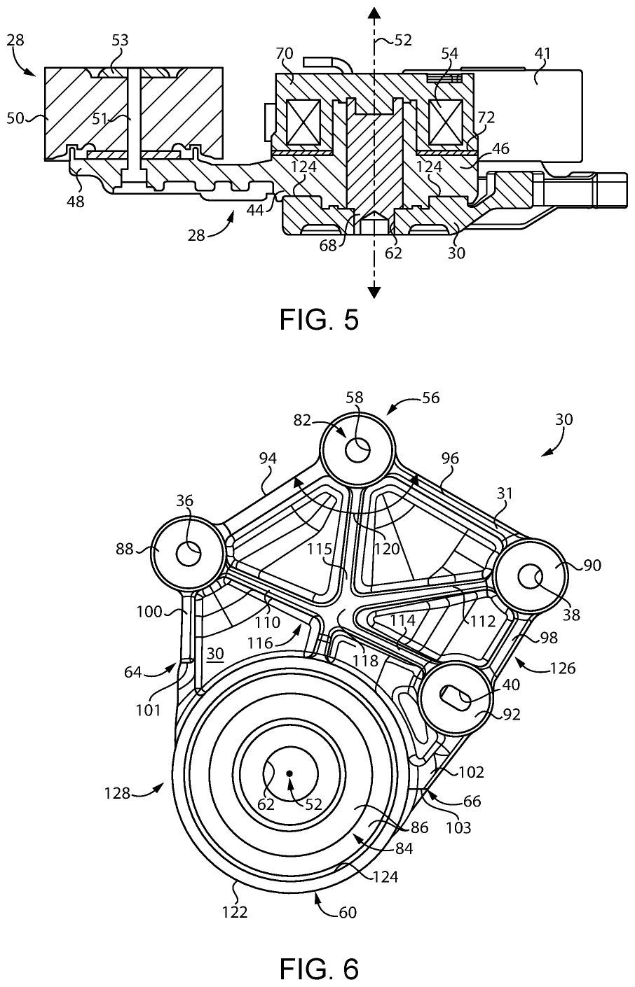

Referring now also to FIGS. 4 and 5, there are shown still further features of module 28. As discussed above, auto-tensioner 42 pivots about pivot axis 52 between a first stop position and a second stop position. In FIG. 3 an angular range 55 of pivoting is shown, representing pivoting motion of auto-tensioner 42 relative to bracket 30. Second arm end 48 may be positioned peripherally outward of bracket 30 at each of the first stop position and the second stop position, and the angular range 55 about pivot axis 52 between the first stop position and the second stop position may be less than 45°, and may be less than 30° in some embodiments. Bracket 30 may further include a first tensioner stop 64 contacted by tensioner arm 44 at the first stop position, and a second tensioner stop 66 contacted by tensioner arm 44 at the second stop position. First tensioner stop 64 and second tensioner stop 66 may be formed integrally in bracket 30, as further discussed herein. As depicted in FIG. 4, first arm end 46 may include an outer peripheral surface 74 extending circumferentially around pivot axis 52, and a stop protrusion 76 extending radially outward and axially downward from outer peripheral surface 74 and positioned to contact second tensioner stop 66 at the second stop position.

FIG. 5 also illustrates further features of module 28, some of which are internal to the illustrated components. Tensioner pulley 50 may include a pulley shaft 51 received in a pulley mounting hole 49 formed in second arm end 48, and a cap 53 fixing tensioner pulley 50 for rotation about pulley shaft 51, upon second arm end 48. Bracket 30 may further include a pivot pin hole 62 formed in second bracket end 60, and auto-tensioner 42 may include a pivot pin 68 positioned in pivot pin hole 62, with pivot pin hole 62 defining pivot axis 52 and supporting first arm end 46 for pivoting auto-tensioner 42 between the first stop position and the second stop position. Auto-tensioner 42 may further have a spring case 70 with a fixed angular orientation about pivot axis 52, and a thrust pad 72 trapped between spring case 70 and first arm end 46. In a practical implementation strategy pivot pin 68 may be press-fit in bracket 30, or attached to bracket 30 by any other suitable strategy. Spring case 70 may be attached to pivot pin 68, such as by way of a splined connection.

Referring also now to FIG. 6, first bracket end 56 includes a pulley mount 82 for mounting pulley 41, and having formed therein a pulley mounting hole 58 extending between engine facing side 32 and outer bracket side 34. Second bracket end 60 includes a tensioner mount 84 having pivot pin hole 62 formed therein and extending between engine facing side 32 and outer bracket side 34. In the illustrated embodiment pulley mount 82 can include a mounting boss structured to receive a shaft or pin of pulley 41 in pulley mounting hole 58. Tensioner mount 84 may include a generally circularly shaped tensioner mounting surface that is circumferentially uniform about pivot axis 52, or substantially circumferentially uniform, and having a stepped-down profile in a radially inward direction, as shown in FIG. 5. A circumferential groove 124 may be formed in tensioner mounting surface 86.

It can also be noted from FIG. 6 that bolting holes 36, 38, and 40 are arranged in a triangular pattern. In a practical implementation strategy bracket 30 includes a total of three bolting holes. Tensioner mounting surface 86 is located entirely outside of the triangular pattern defined by bolting holes 36, 38, and 40 in the illustrated embodiment. Bracket 30 may further be understood to be configured in a mounting section 126, and a tensioner section 128, with a body outer surface 130 formed in part upon each of mounting section 126 and tensioner section 128. Bracket 30 also includes a plurality of bolt bosses 88, 90, and 92 arranged longitudinally between pulley mount 82 and tensioner mount 84 and having formed therein, respectively, bolting holes 36, 38, and 40. Bolting hole 40 may be oval, or otherwise elongated and non-circular, assisting in accommodating tolerances in the positioning of bolt holes in engine 12 that register with bolt holes 36, 38, and 40.

Bracket 30 further includes a plurality of outside ribs including a first outside rib 94 and a second outside rib 96 extending between pulley mount 82 and a first one 88 and a second one 90, respectively, of bolt bosses 88, 90, 92. A third outside rib 98 extends between the second one 90 of the respective bolt bosses and a third one 92 of the respective bolt bosses. Bracket 30 still further includes a plurality of inside ribs 110, 112, 114, and 115 together forming a stiffener 116 connecting between each of bolt bosses 88, 90, 92 upon outer bracket side 34. At least one, typically both, of first tensioner stop 64 and second tensioner stop 66 may include a stop surface 101 and 103, respectively, formed on one of outside ribs 100 and 102. Outside ribs 100 and 102 extend from bolt bosses 89 and 92, respectively, and terminate at stop surfaces 101 and 102. Other tensioner stops such as protrusions, separate stop pieces installed in bracket 30, for example, might be used in other embodiments. First tensioner stop 64 is located adjacent to tensioner mounting surface 86 at a first angular orientation about pivot axis 52, defined by pivot tin hole 62, and second tensioner stop 66 may be located adjacent to tensioner mounting surface 86 at a second angular orientation about pivot axis 52.

It can further be noted from FIG. 6 that first outside rib 94 and second outside rib 96 extend angularly, outwardly, and downwardly from pulley mount 82 to bolt boss 88 and bolt boss 90, respectively. Outside rib 94 and outside rib 96 together form an obtuse angle 120 opening in a direction of second bracket end 60. Bracket 30 further includes a curvilinear peripheral edge 122 upon second bracket end 60 forming a circular arc opening in a direction of first bracket end 56. Inside ribs 110, 112, 114, 115 intersect at a junction 118, and extend outwardly from junction 118 to the respective bolt bosses 86, 88, and 90, and pulley mount 82. The respective inside ribs forming stiffener 116, can assist in providing structural integrity and stiffening of mounting section 126, with tensioner section 128 projecting generally outward from mounting section 126 to support auto-tensioner 42. It will thus be appreciated that bracket 30 provides a robust mounting interface, including with some flexibility for tolerance in bolts and/or bolt hole locations, with a centrally located mounting interface formed by bolt bosses 88, 90, 92 and stiffener 116, to support pulley mount 82 and tensioner mount 84 on opposite sides thereof.

### INDUSTRIAL APPLICABILITY

As discussed above, certain known pulley tensioning and mounting systems require multiple separate mounts for multiple separate components of an accessory drive system in an engine. According to the present disclosure, an auto-tensioner and idler pulley can be co-packaged in a single component that can be quickly and easily installed for service, or removed, using a single mounting interface provided by bracket 30 upon an engine. The present disclosure is contemplated to reduce unnecessary idlers in an accessory drive system as well as reduced mounting hardware and installation labor.

During service, flywheel 14 will rotate to advance belt 16 around accessories 20, 22, 24, idler 18, and module 28. Auto-tensioner 42, based upon a biasing force of tensioner biaser 54, will urge belt 16 inwardly in the illustrated configuration, to maintain a desired tension on belt 16. Repair or routine servicing of engine 10 can include replacing pulleys or other components of module 28, and reusing bracket 30, or swapping in a new belt guide and tensioning module for module 28 provided as a complete assembly.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. An accessory drive system for an engine comprising:
a one-piece bracket having an engine-facing side, an outer bracket side, and a plurality of bolting holes extending between the engine-facing side and the outer bracket side;
a first pulley coupled to the one-piece bracket and supported for rotation upon the outer bracket side;
an auto-tensioner including a tensioner arm having a first arm end coupled to the one-piece bracket, a second arm end, and a tensioner pulley supported for rotation upon the second arm end;
the first arm end is supported for rotation upon the one-piece bracket to pivot the auto-tensioner about a pivot axis between a first stop position and a second stop position, relative to the one-piece bracket; and
a tensioner biaser biasing the auto-tensioner toward the first stop position.

2. The accessory drive system of claim 1 wherein the one-piece bracket includes a first tensioner stop contacted by the tensioner arm at the first stop position, and a second tensioner stop contacted by the tensioner arm at the second stop position.

3. The accessory drive system of claim 2 wherein the one-piece bracket further includes a pivot pin hole extending between the engine-facing side and the outer side, and the auto-tensioner includes a pivot pin positioned in the pivot pin hole and supporting the first arm end for pivoting the auto-tensioner between the first stop position and the second stop position.

4. The accessory drive system of claim 3 wherein the auto-tensioner further includes a spring case having a fixed angular orientation about the pivot axis, and a thrust pad trapped between the spring case and the first arm end.

5. The accessory drive system of claim 3 wherein the one-piece bracket further includes a pulley mount, and a tensioner mount having a tensioner mounting surface extending circumferentially around the pivot axis and in contact with the first arm end.

6. The accessory drive system of claim 5 wherein the plurality of bolting holes includes a total of three bolting holes arranged in a triangular pattern.

7. The accessory drive system of claim 6 wherein the pulley mount and the tensioner mount are each located outside of the triangular pattern.

8. The accessory drive system of claim 2 wherein the one-piece bracket further includes a plurality of inside ribs and a plurality of outside ribs, and at least one of the first tensioner stop or the second tensioner stop includes a stop surface formed on one of the plurality of outside ribs.

9. The accessory drive system of claim 8 wherein the first arm end further includes an outer peripheral surface extending circumferentially around the pivot axis, and a stop protrusion extending radially outward and axially downward from the outer peripheral surface and positioned to contact the second tensioner stop at the second stop position.

10. The accessory drive system of claim 1 further comprising a removable fastener trapped between the auto-tensioner and the one-piece bracket and fixing the auto-tensioner at a third position angularly between the first stop position and the second stop position.

11. A belt guide and tensioning module for an accessory drive system in an engine comprising:
a one-piece bracket having an engine-facing side, an outer bracket side, and a plurality of bolting holes extending between the engine-facing side and the outer bracket side;
the one-piece bracket further including a first bracket end having a first pulley mounting hole formed therein, a second bracket end having a pivot pin hole formed therein,
a first tensioner stop;
a second tensioner stop; and
an auto-tensioner including a pivot pin received in the pivot pin hole, a tensioner arm having a first arm end coupled to the pivot pin and a second arm end having a second pulley mounting hole formed therein, and a tensioner biaser;
the auto-tensioner is supported for rotation about the pivot axis relative to the one-piece bracket, in opposition to a biasing force of the tensioner biaser, from a first stop position in contact with the first tensioner stop to a second stop position in contact with the second tensioner stop.

12. The module of claim 11 wherein the second arm end is positioned peripherally outward of the one-piece bracket at each of the first stop position and the second stop position, and an angular range about the pivot axis between the first stop position and the second stop position is less than 45°.

13. The module of claim 11 wherein each of the first tensioner stop and the second tensioner stop is formed integrally in the one-piece bracket.

14. The module of claim 13 wherein the one-piece bracket includes a plurality of inside ribs and a plurality of outside ribs.

15. The module of claim 14 wherein at least one of the first tensioner stop or the second tensioner stop includes a stop surface formed on one of the plurality of outside ribs.

16. The module of claim 11 wherein the plurality of bolting holes includes a total of three bolting holes arranged in a triangular pattern.

17. The module of claim 16 wherein the one-piece bracket includes a tensioner mount having a tensioner mounting surface extending circumferentially around the pivot pin hole and located outside of the triangular pattern.

18. A bracket for mounting an idler pulley and an auto-tensioner in an accessory drive system for an engine comprising:
a one-piece bracket body having an engine-facing side and an outer bracket side, a first bracket end, and a second bracket end;
the first bracket end including a pulley mount having a pulley mounting hole, and the second bracket end including a tensioner mount having a pivot pin hole;
the one-piece bracket body further including a plurality of bolt bosses arranged longitudinally between the pulley mount and the tensioner mount and each having formed therein a bolting hole extending between the engine-facing side and the outer bracket side, and the bolting holes arranged in a triangular pattern;
the one-piece bracket body further including a plurality of outside ribs including a first outside rib and a second outside rib extending between the pulley mount and a first one and a second one, respectively, of the plurality of bolt bosses, and a third outside rib extending between the second one of the plurality of bolt bosses and a third one of the plurality of bolt bosses; and
the one-piece bracket body further including a plurality of inside ribs together forming a stiffener connecting between each of the plurality of bolt bosses upon the outer bracket side.

19. The bracket of claim 18 wherein the first outside rib and the second outside rib together form an obtuse angle opening in a direction of the second bracket end, and the one-piece bracket body further includes a curvilinear peripheral edge upon the second bracket end forming a circular arc opening in a direction of the first bracket end.

20. The bracket of claim 19 wherein the one-piece bracket body further includes a first tensioner stop located adjacent to the tensioner mounting surface at a first angular orientation about a pivot axis defining by the pivot pin hole, and a second tensioner stop located adjacent to the tensioner mounting surface at a second angular orientation about the pivot axis.
